(19) United States
(12) Patent Application Publication
(10) Pub. No.: US 2019/0208025 A1
(43) Pub. Date: Jul. 4, 2019

(54) SYSTEMS AND METHODS FOR NOTIFICATION SEND CONTROL USING NEGATIVE SENTIMENT

(71) Applicant: Facebook, Inc., Menlo Park, CA (US)

(72) Inventors: Qingyuan Kong, Union City, CA (US); Ashish Kumar Yadav, Mountain View, CA (US); Daniel Dinu, Sunnyvale, CA (US)

(21) Appl. No.: 15/856,424

(22) Filed: Dec. 28, 2017

(51) Int. Cl. H04L 29/08; G06F 15/18; G06F 17/30; G06Q 50/00

(52) U.S. Cl. CPC H04L 67/22; G06F 15/18; G06Q 50/01; G06F 17/3089; G06F 17/30867

(57) ABSTRACT

Systems, methods, and non-transitory computer readable media are configured to determine a likelihood of a rejection of a notification proposed for delivery to a recipient. A delivery determination for the notification can be performed. Subsequently, the notification can be delivered to the recipient based on the delivery determination.

### FIELD OF THE INVENTION

The present technology relates to computerized sending of notifications. More particularly, the present technology relates to techniques for using negative sentiment to control computerized sending of notifications in a networking system.

### BACKGROUND

Users often utilize computing devices for a wide variety of purposes. For example, users of a social networking system can use their computing devices to interact with one another, access content, share content, and create content. The social networking system can deliver various notifications to these users. For example, a given user of the social networking system can administer a page on the social networking system. The social networking system can deliver to this user a notification which encourages the user to perform one or more specified actions with regard to the page. As another example, a first user of the social networking can follow a second user on the social networking system. In this example, the social networking system can deliver to the first user a notification which informs the first user that the second user has made a post.

### SUMMARY

Various embodiments of the present disclosure can include systems, methods, and non-transitory computer readable media configured to determine a likelihood of a rejection of a notification proposed for delivery to a recipient. A delivery determination for the notification can be performed. Subsequently, the notification can be delivered to the recipient based on the delivery determination.

In an embodiment, a likelihood of a selection of the notification can be determined.

In an embodiment, determining the likelihood of the rejection of the notification can be based on a machine learning model.

In an embodiment, feature data for the notification can be provided to the machine learning model.

In an embodiment, feature data for the recipient can be provided to the machine learning model.

In an embodiment, feature data regarding previous delivery of the notification to the recipient can be provided to the machine learning model.

In an embodiment, performing the delivery determination for the notification can be based at least in part on the likelihood of the rejection of the notification.

In an embodiment, performing the delivery determination for the notification can be based at least in part on the likelihood of the selection of the notification.

In an embodiment, performing the delivery determination for the notification can be based at least in part on a weight applied to the likelihood of the rejection of the notification.

In an embodiment, performing the delivery determination for the notification can further comprise generating a score based at least in part on the likelihood of the rejection of the notification, a selected weight applied to the likelihood of the rejection of the notification, and a likelihood of a selection of the notification. Subsequently, the score can be compared to a threshold value.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example notification control module, according to an embodiment of the present disclosure.

FIG. 2 illustrates an example prediction module, according to an embodiment of the present disclosure.

FIG. 3 illustrates an example decision module, according to an embodiment of the present disclosure.

FIG. 4 illustrates an example functional block diagram, according to an embodiment of the present disclosure.

FIG. 5 illustrates an example process, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Notification Send Control Using Negative Sentiment

Users often utilize computing devices for a wide variety of purposes. For example, users of a social networking system can use their computing devices to interact with one another, access content, share content, and create content. The social networking system can deliver various notifications to these users. For example, a given user of the social networking system can administer a page on the social networking system. The social networking system can deliver to this user a notification which encourages the user to perform one or more specified actions with regard to the page. As another example, a first user of the social networking can follow a second user on the social networking system. In this example, the social networking system can deliver to the first user a notification which informs the first user that the second user has made a post.

By sending notifications, the social networking system can provide the users of the social networking system with enhanced experiences. For example, higher quality pages on the social networking system can flow from notifications which encourage users, such as page admins, to take actions which improve pages which they administrate. As another example, a first user can more easily learn of new posts made by second user when notifications draw attention to the new posts. However, as one illustration, a user who receives too many notifications from the social networking can come to harbor negative sentiment towards the social networking system or entities of the social networking system to which the notifications may be attributed. Conventional approaches tend to select and deliver to users notifications which the users are predicted to enjoy. However, these approaches can tend to fail to adequately address negative sentiment. As one illustration, notifications of a sort which may prove enjoyable to a user in small quantities can prove irritating when received by that user in large quantities.

Due to these or other concerns, the aforementioned and other conventional approaches specifically arising in the realm of computer technology can be disadvantageous or problematic. Therefore, an improved approach can be beneficial for addressing or alleviating various drawbacks associated with conventional approaches. Based on computer technology, the disclosed technology can use negative sentiment in controlling deliveries of notifications to users of a social networking system. In some embodiments, the social networking system can receive a request to deliver a notification to a user of the social networking system. The social networking system can use one or more machine learning models to determine a likelihood of the user rejecting the notification. The social networking system can also use one or more machine learning models to determine a likelihood of the user selecting the notification. Subsequently, the social networking system can calculate a score which considers the two likelihoods. The social networking system can then compare the score to a threshold. Where the score does not meet the threshold, the social networking system does not deliver the notification to the user. Where the score meets or exceeds the threshold, the social networking system can deliver the notification to the user. More details regarding the discussed technology are provided herein.

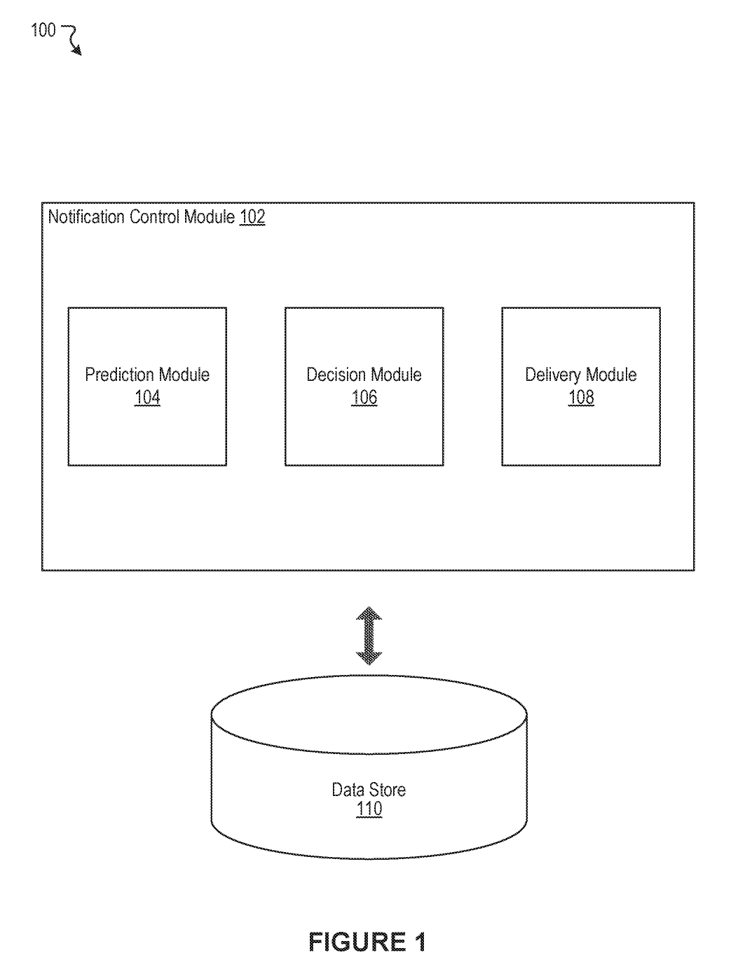

FIG. 1 illustrates an example system 100 including an example notification control module 102, according to an embodiment of the present disclosure. As shown in the example of FIG. 1, the notification control module 102 can include a prediction module 104, a decision module 106, and a delivery module 108. In some instances, the example system 100 can include at least one data store 110. The components (e.g., modules, elements, etc.) shown in this figure and all figures herein are exemplary only, and other implementations can include additional, fewer, integrated, or different components. Some components may not be shown so as not to obscure relevant details. In some embodiments, the notification control module 102 can be implemented in a system, such as a social networking system. While the disclosed technology may be described herein in connection with a social networking system for illustrative purposes, the disclosed technology can be implemented in any other type of system or environment.

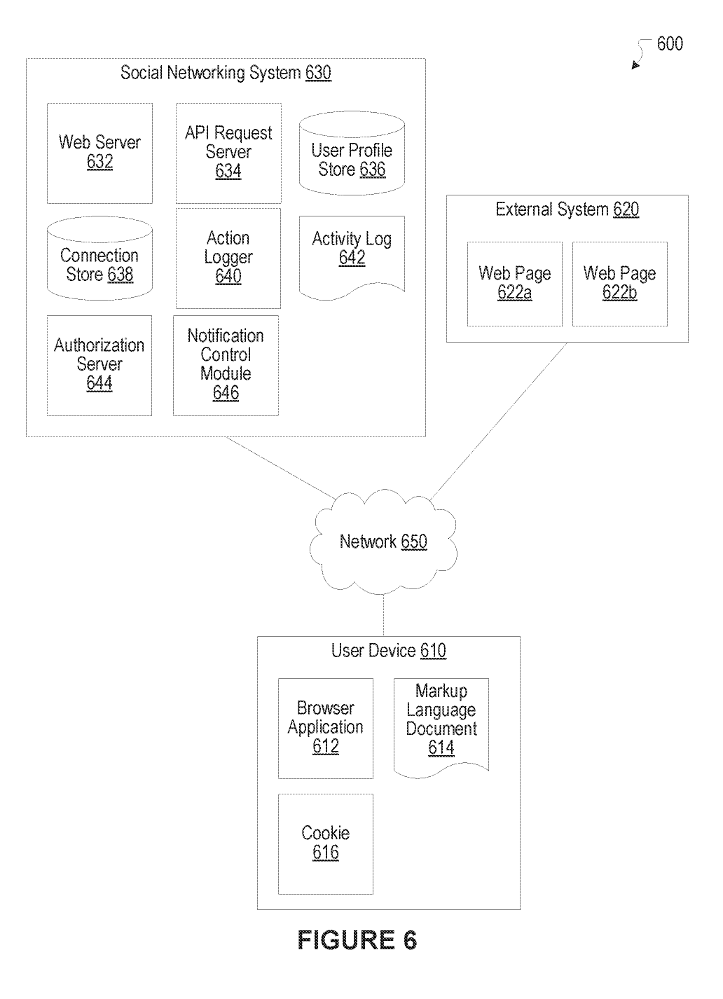

In some embodiments, the notification control module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the notification control module 102 can be implemented, in part or in whole, as software running on one or more computing devices or systems. For example, the notification control module 102 or at least a portion thereof can be implemented using one or more computing devices or systems that include one or more servers, such as network servers or cloud servers. In another example, the notification control module 102 or at least a portion thereof can be implemented as or within an application (e.g., app), a program, an applet, or an operating system, etc., running on a user computing device or a client computing system, such as a user device 610 of FIG. 6. In some instances, the notification control module 102 can, in part or in whole, be implemented within or configured to operate in conjunction with a system (or service), such as a social networking system 630 of FIG. 6. The application incorporating or implementing instructions for performing functionality of the notification control module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that there can be many variations or other possibilities.

The notification control module 102 can be configured to communicate and/or operate with the at least one data store 110, as shown in the example system 100. The at least one data store 110 can be configured to store and maintain various types of data. For example, the data store 110 can store information used or generated by the notification control module 102. The information used or generated by the notification control module 102 can include, for example, machine learning model persistence data, log data, and lookup data. In some implementations, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data.

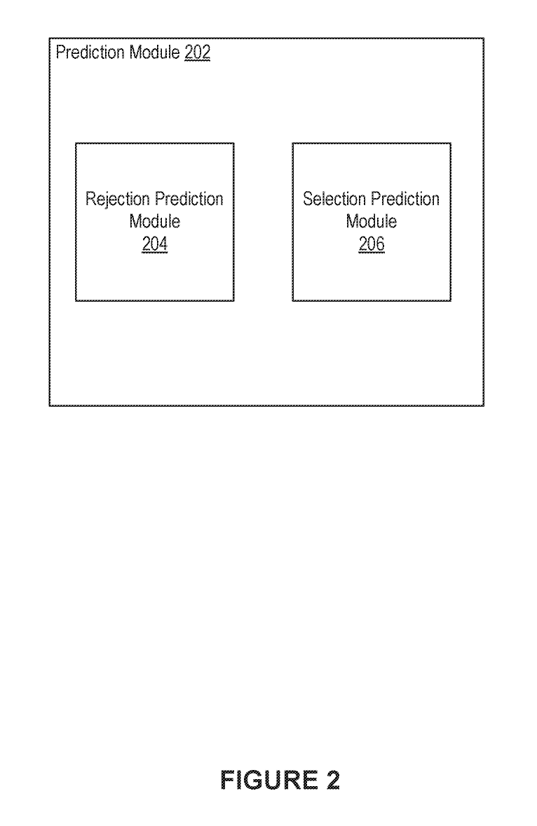

The prediction module 104 can generate a prediction that a recipient will reject a notification. The recipient can include, for example, an administrator of a page of a social networking system. The prediction module 104 can also generate a prediction that a recipient will select a notification. The prediction module 104 can be used to inform a decision of whether or not to deliver a notification to a recipient. Additional details regarding the prediction module 104 are provided below with reference to FIG. 2.

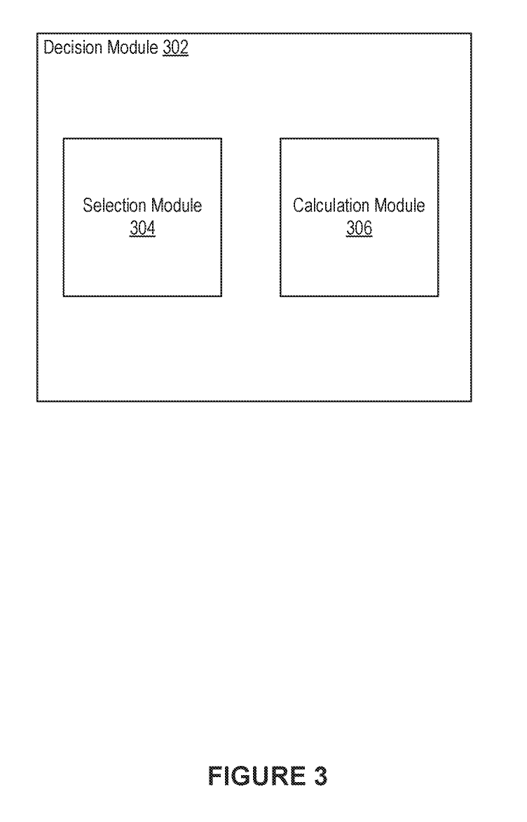

The decision module 106 can generate a decision as to whether or not a notification should be delivered to a recipient. The decision can be based on one or more machine learning models, weights, and thresholds. Additional details regarding the decision module 106 are provided below with reference to FIG. 3.

The delivery module 108 can deliver a notification to a recipient. The recipient can be a user of a social networking system. The delivery module 108 can receive a request to potentially deliver the notification from a notification source. In some embodiments, the notification source can be a process or resource of a social networking system which selects or generates notifications for users of the social networking system. In some embodiments, the notification can be a panel. For instance, the panel can provide a suggestion of one or more actions which the recipient can perform with respect to a page administered by the recipient. As one illustration, a suggested action can be adding an image, or other media, to the page. As another illustration, a suggested action can be adding a button to the page. In particular, the suggestion can be to add a button which allows a page visitor to place a food or merchandise order with a business affiliated with the page. In some embodiments, the notification can be or relate to a post. As an illustration, the post can be a post of a page followed by the recipient, or a post of a user of the social networking system whom the recipient follows. A channel of the social networking system through which the notification can be delivered can be selected. Examples of a channel of the social networking system include a homepage, a feed (e.g., newsfeed), and messaging-related communications. Many variations are possible.

The delivery module 108 can receive, from the decision module 106, either an indication that the notification should be delivered or an indication that the notification should not be delivered. Where the delivery module 108 receives the indication that the notification should not be delivered, the delivery module 108 does not deliver the notification. Where the delivery module 108 receives the indication that the notification should be delivered, the delivery module 108 can deliver the notification to the recipient. The notification to the recipient can delivered through the selected channel.

The recipient of the notification can use an interface presented by a user computing device to perform an action with respect to the notification. The actions can include selecting the notification and rejecting the notification. In some embodiments, the recipient can also be able to choose to perform no action with respect to the notification. Where the recipient selects the notification, the interface can present to the recipient a destination associated with the notification. As an example, where the notification is a panel which provides a suggestion of one or more actions to perform with respect to a page, the destination can be the page. As another example, where the notification is or relates to a post, the destination can be a page which authored the post, or a profile of a user who authored the post. Many variations are possible. Where the recipient rejects the notification, the notification can be withdrawn. As one example, where the notification is a panel and the channel is a homepage of the recipient, the panel can be removed from the homepage. As another example, where the notification is a post and the channel is a feed of the recipient, the post can be removed from the feed. There can be many variations or other possibilities. In some embodiments, where the recipient chooses to perform no action with respect to the notification, the notification can be retained.

In some embodiments, the delivery module 108 can maintain a log of deliveries of notifications to recipients. In these embodiments, after delivering the notification to the recipient, the delivery module 108 can add an entry to the log. The entry can indicate the recipient, the notification, and the channel. Further, the delivery module 108 can maintain a log of actions taken by recipients with regard to notifications. After the recipient has performed an action with respect to the notification, the delivery module 108 can add an entry to the log. The entry can indicate the recipient, the notification, and the action chosen. The entry can also indicate the channel used to deliver the notification. In some embodiments, the prediction module 104 can use the log in training or retraining one or more machine learning models used by the prediction module 104, as discussed in more detail herein.

The delivery module 108 can calculate one or more metrics regarding the notifications which it delivers to recipients. As one example, the delivery module 108 can calculate a negative sentiment metric. As examples, the negative sentiment metric can quantify user feelings of annoyance, anger, irritation, and the like. Many variations are possible. The delivery module 108 can calculate the negative sentiment metric with respect to each of one or more of the recipients. As one example, a negative sentiment metric for a given recipient recipient can be calculated as NS_{recipient}:

$${NS}_{recipient} = k \cdot {\sum }_{u = 0}^{n} \frac{{Xout}_{u}}{{w}_{u}} \qquad ( 1 )$$

In the equation, u can be a given delivered unique notification, and n can be the number of unique notifications which were delivered. As an illustration, one unique notification can be a panel suggesting that a particular action be performed for a page, while a second unique notification can be a panel suggesting that a different action be performed for the page. Also in the equation, Xoutᵤ can be a number of times the given recipient has rejected the unique notification u. Further in the equation, wᵤ can be a number of times the unique notification u was delivered to the given recipient. Also in the equation, k can be a constant. In some embodiments, k can be chosen through experimentation. In some embodiments, other approaches can be used to determine the negative sentiment metric for the recipient. For example, the delivery module 108 can use an interface presented by a user computing device to provide a survey to the recipient. The survey can list one or more notifications delivered to the recipient in the past. For each of the listed notifications, the survey can ask the recipient to indicate whether or not the notification caused the recipient to experience a negative sentiment. Subsequently, the delivery module 108 can calculate the negative sentiment metric for the recipient as a number of notifications which caused negative sentiment, divided by a total number of notifications sent to the recipient. Many variations are possible.

As another example, the delivery module 108 can calculate a location action metric. The delivery module 108 can calculate the location action metric with respect to each of one or more of the recipients, and with respect to each of one or more locations on the social networking system. The location action metric can quantify an extent to which a given recipient is active with respect to a given location on the social networking system. As one illustration, the given location can be a page on the social networking system which is administered by the given recipient. As another illustration, the given location can be a profile of a user followed by the given recipient. As a further illustration, the given location can be a page on the social networking system followed by the given recipient. As one example, a location action metric can be calculated for the given recipient recipient and the given location location as:

$${LA}_{recipient , location} = j \cdot {\sum }_{v = 0}^{m} \frac{cli {ck}_{v}}{{q}_{v}} \qquad ( 2 )$$

In the equation, v can be a given delivered unique notification which has location as a destination. Also in the equation, m can be a number of unique notifications delivered which have location as a destination. Further in the equation, clickᵥ can be a number of times the given recipient has selected the unique notification v. Also in the equation, qᵤ can be a number of times the unique notification v was delivered to the given recipient. Further in the equation, j can be a constant. In some embodiments, j can be chosen through experimentation. Many variations are possible.

FIG. 2 illustrates an example prediction module 202, according to an embodiment of the present disclosure. In some embodiments, the prediction module 104 of FIG. 1 can be implemented as the example prediction module 202. As shown in FIG. 2, the prediction module 202 can include a rejection prediction module 204 and a selection prediction module 206.

The rejection prediction module 204 can access one or more machine learning models suitably trained to provide predictions regarding a likelihood of a recipient rejecting a notification. The machine learning models can apply any generally known approach for classification. In various embodiments, each of the machine learning models can accept certain inputs and return certain outputs. In one implementation, one type of input can include, for example, feature data for a recipient. As one example, feature data for the recipient can include a number of notifications the recipient receives. As another example, feature data for the recipient can include a kind of business with which the recipient is affiliated. In some embodiments, the kind of business with which the recipient is affiliated can be reflected by a page administered by the recipient. As a further example, feature data for the recipient can include a likelihood of the recipient to either select or reject a notification within a preselected number of days, or other time duration, after delivery. As an additional example, feature data for the recipient can include kinds of posts or stories created by the recipient. As yet another example, feature data for the recipient can include kinds of posts or stories read by the recipient. In some embodiments, feature data indicating kinds of posts or stories can include feature data for text and media of the posts or stories. Another type of input can include, for example, feature data for a notification. As an example, the feature data for the notification can include feature data for text and media of the notification. As another example, the feature data for the notification can include feature data which relates to timing of the notification, such as a delivery time of the notification. In some embodiments, yet another type of input can include, for example, a feature vector which indicates, for each of one or more channels of the social networking system, whether or not the notification was previously delivered to the recipient using the channel. Many variations are possible with respect to the types of inputs and related feature data that can be provided to a machine learning model. An output of the machine learning model can be a prediction of a likelihood that the recipient will reject the notification. In some embodiments, the output of the machine learning model can provide a prediction of a likelihood that the recipient will reject the notification if the notification is delivered using a given channel of the social networking system. As an illustration, the output of the machine learning model can provide a prediction regarding delivery of the notification using a feed. In some embodiments, the rejection prediction module 204 can have access to a plurality of machine learning models to predict a likelihood that the recipient will reject the notification, and each of the plurality of machine learning models can correspond to a particular channel of the social networking system through which the notification can be delivered.

The rejection prediction module 204 can determine a likelihood that a recipient will reject a notification proposed for potential delivery to the recipient. The rejection prediction module 204 can provide inputs to one of the machine learning models to determine the likelihood that the recipient will reject the notification. In one implementation, the inputs can be, for example, feature data for the recipient and feature data for the notification. In some embodiments, a further input can be a feature vector which indicates, for each of one or more channels of the social networking system, whether the notification was previously delivered to the recipient using the channel, as discussed above. The rejection prediction module 204 can populate the vector using the log of deliveries of notifications to recipients which is maintained by the delivery module 108. The rejection prediction module 204 can receive from the machine learning model an output indicating a likelihood that the recipient will reject the notification.

The selection prediction module 206 can access one or more machine learning models suitably trained to provide predictions regarding a likelihood of a recipient selecting a notification. Each of the trained machine learning models can correspond to notification delivery using a different channel of the social networking system. In one implementation, each of the machine learning models to which the selection prediction module 206 has access can accept a variety of inputs and can return a variety of outputs. The inputs can include, for example, feature data for a recipient and feature data for a notification. In some embodiments, a further input can be a feature vector regarding previous delivery of the notification, as discussed in connection with the rejection prediction module 204. An output of the machine learning model can be a prediction of a likelihood that the recipient will select the notification. In some embodiments, the output of the machine learning model is associated with a particular channel of a social networking system, and can provide a prediction of a likelihood that the recipient will select the notification when the notification is delivered through the particular channel.

The selection prediction module 206 can determine a likelihood that a recipient selects a notification proposed for potential delivery to the recipient. The selection prediction module 206 can provide inputs to the machine learning model to determine the likelihood that the recipient will select the notification. In one implementation, the inputs to the machine learning model can include, for example, feature data for the recipient and feature data for the notification. In some embodiments, the inputs can also include a feature vector which regards previous delivery of the notification, as discussed above. The selection prediction module 206 can receive an output from the machine learning model indicating a likelihood that the recipient will select the notification. One or more machine learning models discussed in connection with the notification control module 102 and its components can be implemented separately or in combination, for example, as a single machine learning model, as multiple machine learning models, as one or more staged machine learning models, as one or more combined machine learning models, etc.

FIG. 3 illustrates an example decision module 302, according to an embodiment of the present disclosure. In some embodiments, the decision module 106 of FIG. 1 can be implemented as the example decision module 302. As shown in FIG. 3, the decision module 302 can include a selection module 304 and a calculation module 306.

The selection module 304 can select a machine learning model to predict a likelihood of a recipient selecting a notification, and a machine learning model to predict a likelihood of the recipient rejecting the notification. The selection module 304 can also select a weight a, and a threshold to decide whether or not the notification should be delivered to the recipient. In some embodiments, the selection module 304 can access references, such as a first reference and a second reference, to determine machine learning models, a value for a, and a value for a threshold. In some embodiments, the first reference and the second reference can be a first lookup table and a second lookup table. In one example, the first reference can list one or more channels of the social networking system. For each channel, the first reference can list a machine learning model that can be used in determining a likelihood of a recipient selecting a notification delivered using the channel and a machine learning model that can be used in determining a likelihood of a recipient rejecting a notification delivered using the channel. In this example, the second reference can likewise list one or more channels of the social networking system. For each channel, the second reference can list a value for a and a value for the threshold. In some embodiments, the values for a and the values for the threshold of the second reference can be populated by way of experimentation. As discussed, the delivery module 108 can calculate negative sentiment metrics and location action metrics. Based on the experimentation, for each channel, a value for a and a value for the threshold can be chosen. In some embodiments, for a given channel, a value for a and a value for the threshold can be chosen that achieve a predetermined level of the local action metric while not exceeding a predetermined level of the negative sentiment metric. Many variations are possible. Accordingly, in relation to a proposed notification for a particular recipient in a given channel, the selection module 304 can determine a machine learning model that can be used in determining a likelihood of the recipient selecting the notification delivered using the channel, a machine learning model that can be used in determining a likelihood of the recipient rejecting the notification delivered using the channel, a value for a, and a value for the threshold.

The calculation module 306 can determine, with respect to a particular notification and a particular recipient, whether or not the notification should be delivered to the recipient. The calculation module 306 can calculate a score and compare the score to a threshold. In some embodiments, the score can be calculated as follows:

eSelect−α·eReject (3)

In this equation, eSelect can be a likelihood that the recipient selects the notification; eReject can be a likelihood that the recipient rejects the notification; and α can be a weight. As reflected by the equation, the effect of eReject on the score can be weighted by the magnitude of α.

In some embodiments, the calculation module 306 can receive, from the selection module 304, the specification of the machine learning model that can be used in determining the likelihood of the recipient selecting the notification, the machine learning model that can be used in determining the likelihood of the recipient rejecting the notification, a, and the threshold. The calculation module 306 can receive, from the prediction module 202, a determination of a likelihood that the recipient rejects the notification and a determination of a likelihood that the recipient selects the notification. In particular, the calculation module 306 can receive, from the prediction module 202 a numerical value for the likelihood that the recipient rejects the notification and a numerical value for the likelihood that the recipient selects the notification.

The calculation module 306 can calculate the score using equation (3). In calculating the score, the calculation module 306 can use the likelihood that the recipient rejects the notification as eReject and can use the received likelihood that the recipient selects the notification as eSelect. Also, in calculating the score, the calculation module 306 can use the value of a. The calculation module 306 can then compare a result of the calculation, or the score, to the threshold. Where the score meets or exceeds the threshold, the calculation module 306 can determine that the notification should be delivered, and accordingly the notification is delivered to the recipient. Where the result does not meet the threshold, the calculation module 306 can determine that the notification should not be delivered, and accordingly the notification is not delivered to the recipient.

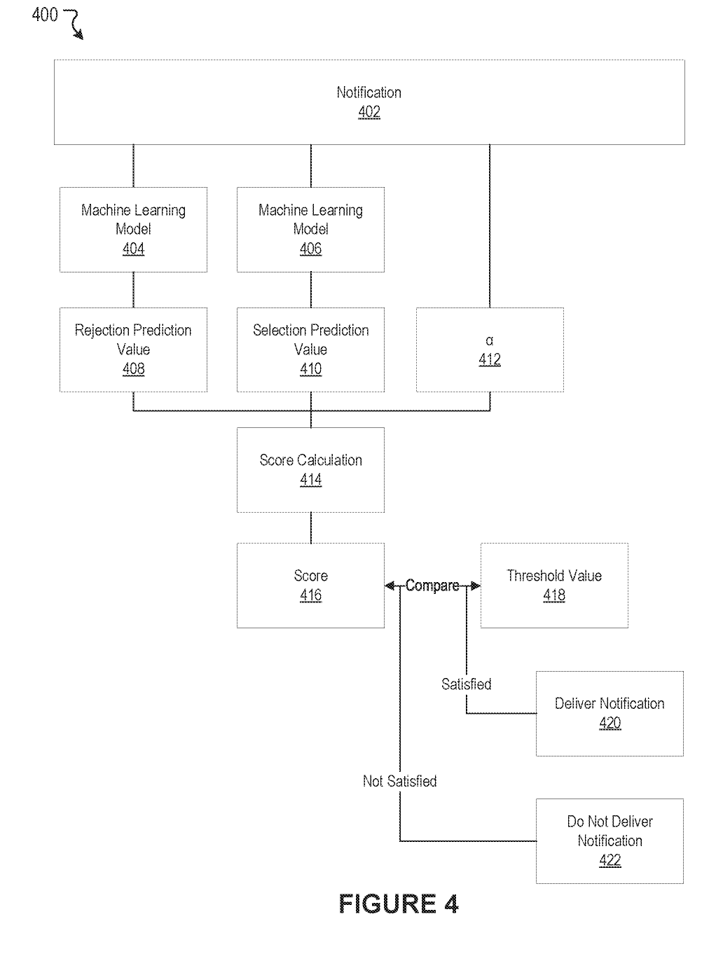

FIG. 4 illustrates an example functional block diagram 400, according to an embodiment of the present disclosure. The functional block diagram 400 illustrates an example of operation of the notification control module 102, as discussed in more detail above. A notification 402 for potential delivery to a recipient through a particular channel of a social networking system is shown. Various input data in relation to the notification 402 can be provided to machine learning models 404, 406. The input data can include, for example, feature data for the recipient, feature data for the notification 402, and a feature vector regarding previous delivery of the notification 402, as discussed above. The machine learning model 404 and the machine learning model 406 can predict a likelihood that the recipient will, respectively, reject and select the notification 402. In some instances, the machine learning models 404, 406 are specific to the particular channel through which the notification 402 is to be delivered. Based on the input data, the machine learning model 404 can generate a prediction regarding a likelihood that the recipient will reject the notification 402. The prediction can be expressed as a rejection prediction value 408 corresponding to eReject, as discussed above in connection with equation (3). Likewise, based on the input data, the machine learning model 406 can generate a prediction regarding a likelihood that the recipient will select the notification 402. The prediction can be expressed as a selection prediction value 410 corresponding to eSelect, as discussed above in connection with equation (3). A value for a 412 and a threshold value 418 can be determined. As discussed in more detail above, the value for a 412 and the threshold value 418 can be based at least in part on a desired levels of a local action metric and a negative sentiment metric.

The rejection prediction value 408, the selection prediction value 410, and the value for a 412 can be provided to score calculation 414, where a score 416 according to equation (3) is calculated. The score 416 can be compared with the threshold value 418. When the score 416 satisfies the threshold value 418, the notification 402 can be delivered at block 420. When the score 416 does not satisfy the threshold value 418, the notification 402 is not delivered at block 422.

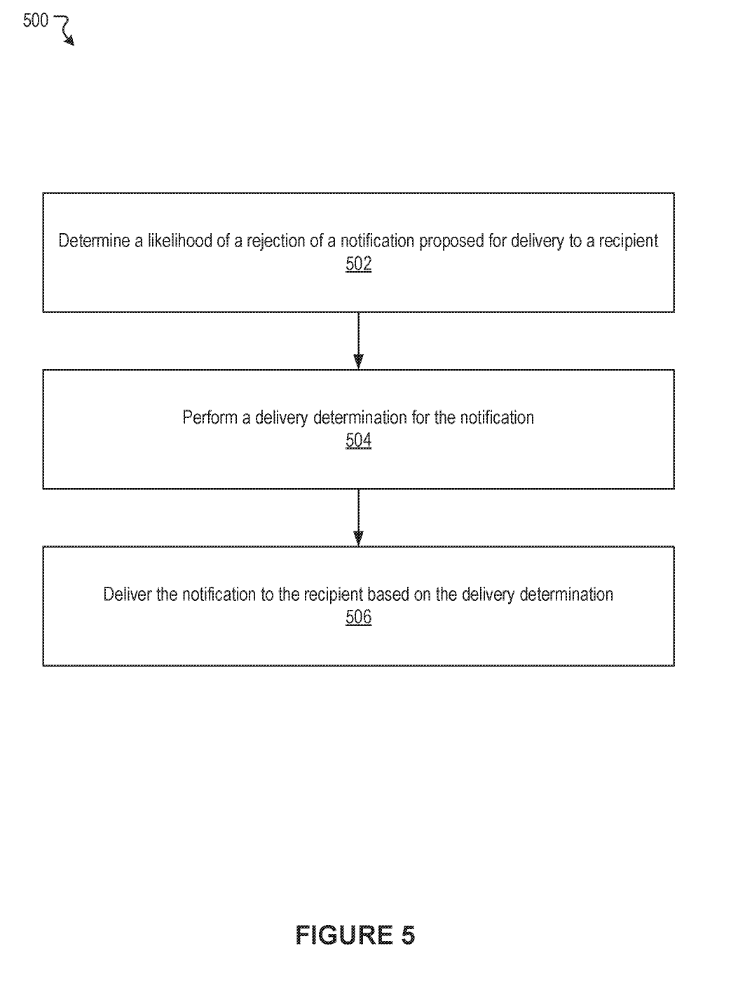

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, the example process 500 can determine a likelihood of a rejection of a notification proposed for delivery to a recipient. At block 504, the process can perform a delivery determination for the notification. Then, at block 506, the process can deliver the notification to the recipient based on the delivery determination.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects another user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a notification control module 646. The notification control module 646 can, for example, be implemented as the notification control module 102 of FIG. 1. In some embodiments, some or all of the functionality and modules of the notification control module 646 (e.g., sub modules of the notification control module 102) instead can be implemented in the user device 610.

### Hardware Implementation

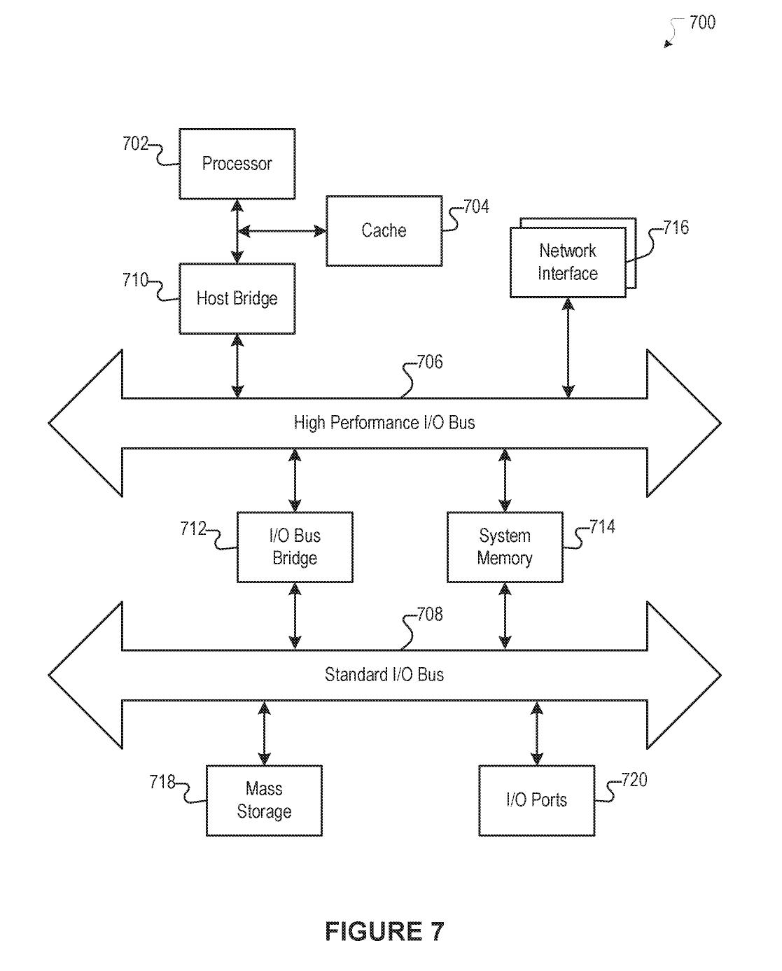

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a likelihood of a rejection of a notification proposed for delivery to a recipient;
performing, by the computing system, a delivery determination for the notification; and
delivering, by the computing system, the notification to the recipient based on the delivery determination.

2. The computer-implemented method of claim 1, further comprising:
determining, by the computing system, a likelihood of a selection of the notification.

3. The computer-implemented method of claim 1, wherein the determining the likelihood of the rejection of the notification is based on a machine learning model.

4. The computer-implemented method of claim 3, further comprising:
providing, by the computing system, to the machine learning model, feature data for the notification.

5. The computer-implemented method of claim 3, further comprising:
providing, by the computing system, to the machine learning model, feature data for the recipient.

6. The computer-implemented method of claim 3, further comprising:
providing, by the computing system, to the machine learning model, feature data regarding previous delivery of the notification to the recipient.

7. The computer-implemented method of claim 1, wherein the performing the delivery determination for the notification is based at least in part on the likelihood of the rejection of the notification.

8. The computer-implemented method of claim 7, wherein the performing the delivery determination for the notification is based at least in part on the likelihood of the selection of the notification.

9. The computer-implemented method of claim 8, wherein the performing the delivery determination for the notification is based at least in part on a weight applied to the likelihood of the rejection of the notification.

10. The computer-implemented method of claim 1, wherein the performing the delivery determination for the notification comprises:
generating a score based at least in part on the likelihood of the rejection of the notification, a selected weight applied to the likelihood of the rejection of the notification, and a likelihood of a selection of the notification; and
comparing the score to a threshold value.

11. A system comprising:
at least one processor; and
a memory storing instructions that, when executed by the at least one processor, cause the system to perform:
determining a likelihood of a rejection of a notification proposed for delivery to a recipient;
performing a delivery determination for the notification; and
delivering the notification to the recipient based on the delivery determination.

12. The system of claim 11, wherein the instructions, when executed by the at least one processor, further cause the system to perform:
determining a likelihood of a selection of the notification.

13. The system of claim 11, wherein the determining the likelihood of the rejection of the notification is based on a machine learning model.

14. The system of claim 11, wherein the performing the delivery determination for the notification is based at least in part on the likelihood of the rejection of the notification.

15. The system of claim 11, wherein the performing the delivery determination for the notification comprises:
generating a score based at least in part on the likelihood of the rejection of the notification, a selected weight applied to the likelihood of the rejection of the notification, and a likelihood of a selection of the notification; and
comparing the score to a threshold value.

16. A non-transitory computer-readable storage medium including instructions that, when executed by at least one processor of a computing system, cause the computing system to perform a method comprising:
determining a likelihood of a rejection of a notification proposed for delivery to a recipient;
performing a delivery determination for the notification; and
delivering the notification to the recipient based on the delivery determination.

17. The non-transitory computer-readable storage medium of claim 16, wherein the instructions, when executed by the at least one processor of the computing system, further cause the computing system to perform:
determining a likelihood of a selection of the notification.

18. The non-transitory computer-readable storage medium of claim 16, wherein the determining the likelihood of the rejection of the notification is based on a machine learning model.

19. The non-transitory computer-readable storage medium of claim 16, wherein the performing the delivery determination for the notification is based at least in part on the likelihood of the rejection of the notification.

20. The non-transitory computer-readable storage medium of claim 16, wherein the performing the delivery determination for the notification comprises:
generating a score based at least in part on the likelihood of the rejection of the notification, a selected weight applied to the likelihood of the rejection of the notification, and a likelihood of a selection of the notification; and
comparing the score to a threshold value.
